(19) United States
(12) Patent Application Publication
(10) Pub. No.: US 2011/0195609 A1
(43) Pub. Date: Aug. 11, 2011

(54) CABLE CONNECTOR ASSEMBLY HAVING A FIRM CONNECTION BETWEEN CONTACTS AND CABLE THEREIN

(75) Inventors: PING-SHENG SU, New Taipei (TW); ZHUANG-ZHI WU, Kunshan (CN); XUE-CHAO WANG, Kunshan (CN)

(73) Assignee: HON HAI PRECISION INDUSTRY CO., LTD., New Taipei (TW)

(21) Appl. No.: 13/016,021

(22) Filed: Jan. 28, 2011

(30) Foreign Application Priority Data
Feb. 9, 2010 (CN) 201020302670.6

(51) Int. Cl. H01R 24/00

(52) U.S. Cl. 439/660

(57) ABSTRACT

A cable connector assembly comprising: an insulative housing (10), a plurality of contacts (11) disposed in the insulative housing (10), each contact (11) having a tail portion (112) extending rearwardly and exposed out of the insulative housing (10), a spacer (12) assembled to a rear end of the insulative housing (10), and the spacer (12) defining a plurality of receiving slots (1212,1213), a receiving cavity (1205) located in front of the receiving slots (1212,1213), and a plurality of vertical holes (1214,1215) communicate with the receiving slots (1212,1213) and the receiving cavity (1205), a cable (2) having a plurality of wires (21) extending into the receiving cavity (1205) through the receiving slots (1212,1213) and the vertical holes (1214,1215), the tail portions (112) of the contacts (11) extended into the spacer (12) and electrically connected with the wires (21), and a insulative piece (9) received in the receiving cavity (1205) and press the wires (21).

### 1. FIELD OF THE INVENTION

The present invention generally relates to a cable assembly, and more particularly to a cable connector assembly for transmitting high speed signals.

### 2. DESCRIPTION OF RELATED ART

Developed by Sony, Hitachi, Thomson (RCA), Philips, Matsushita (Panasonic), Toshiba and Silicon Image, the High-Definition Multimedia Interface (HDMI) has emerged as the connection standard for HDTV and the consumer electronics market. HDMI is the first digital interface to combine uncompressed high-definition video, multi-channel audio and intelligent format and command data in a single digital interface.

An electrical connector in accordance with HDMI standard comprises an insulative housing, a number of contacts received in the insulative housing, a metallic shell shielding the insulative housing and cables connecting with the contacts.

Usually, the cable connector assembly also comprises a spacer molding over the joint portion between the cables and the contacts. Because of the small structure of the exist cable connector assembly, the soldering process of the cables and the contacts becoming more difficultly.

Correspondingly, it is desired to have a cable connector assembly with improved structure to address the problems stated above.

### BRIEF SUMMARY OF THE INVENTION

Accordingly, an object of the present invention is to provide a cable connector assembly unnecessary for soldering process.

In order to achieve the above-mentioned object, a cable connector assembly comprising an insulative housing, a plurality of contacts disposed in the insulative housing, each contact having a tail portion extending rearwardly and exposed out of the insulative housing, a spacer assembled to a rear end of the insulative housing, and the spacer defining a plurality of receiving slots, a receiving cavity located in front of the receiving slots, and a plurality of vertical holes communicate with the receiving slots and the receiving cavity, a cable having a plurality of wires extending into the receiving cavity through the receiving slots and the vertical holes, the tail portions of the contacts extended into the spacer and electrically connected with the wires, and a insulative piece received in the receiving cavity and press the wires.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded, perspective view of a cable connector assembly in accordance with a first embodiment of the present invention;

FIG. 2 is similar to FIG. 1, but viewed from another aspect;

FIG. 3 is an enlarged view of the spacer of the cable connector assembly of FIG. 2;

FIG. 4 is similar to FIG. 3, but viewed from another aspect;

FIG. 5 is an assembled, perspective view of the cable connector assembly of FIG. 1;

FIG. 6 is a cross-section view of FIG. 5, which is removed the metallic shielding, the metallic shell and the cover;

FIG. 7 an exploded, perspective view of a cable connector assembly in accordance with a second embodiment of the present invention;

FIG. 8 is similar to FIG. 7, but viewed from another aspect;

FIG. 9 is a partially assembled, perspective view of the cable connector assembly of FIG. 7;

FIG. 10 is an enlarged view of the spacer of the cable connector assembly of FIG. 9; and

FIG. 11 is a cross-section view of FIG. 9, which is removed the metallic shell.

### DETAILED DESCRIPTION OF THE INVENTION

Reference will now be made to the drawing figures to describe the present invention in detail.

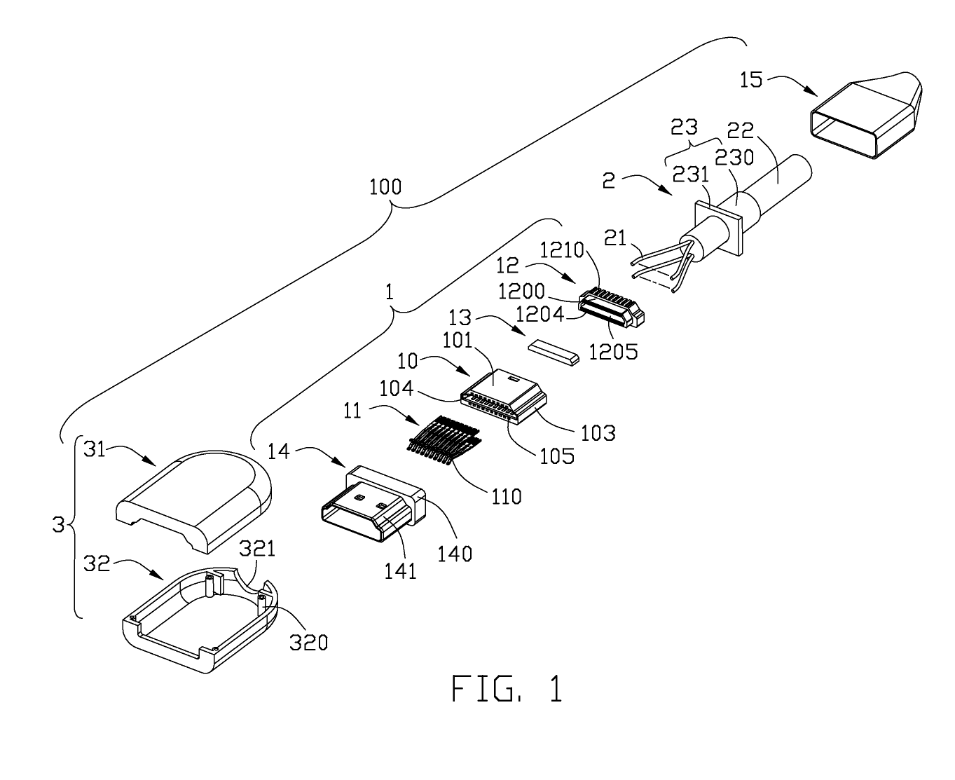

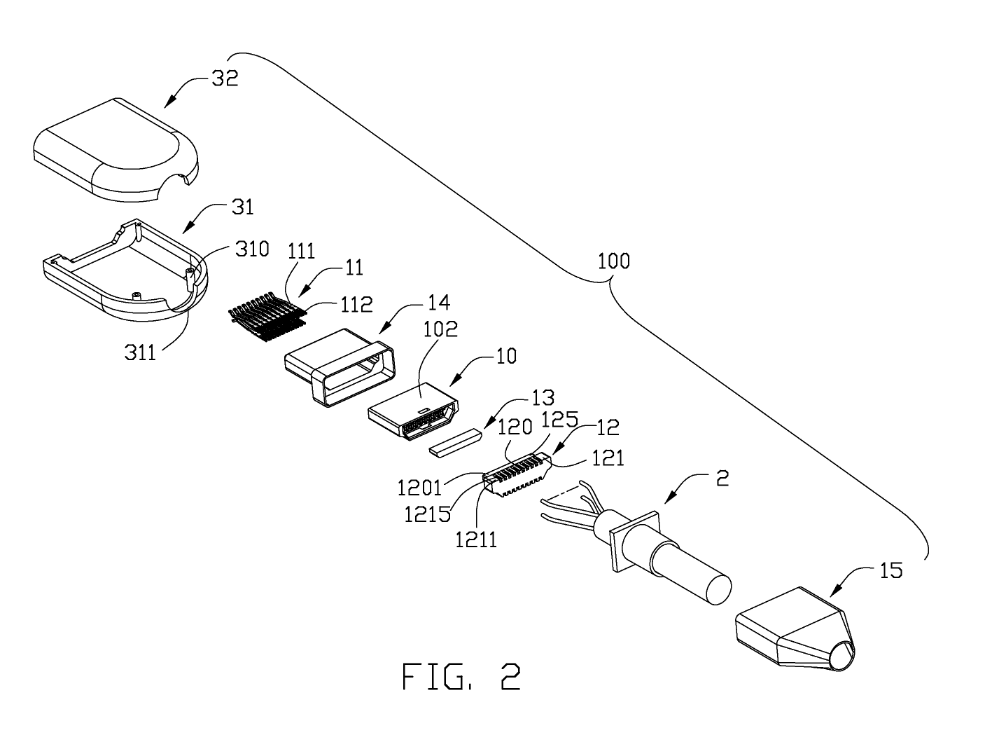

Referring to FIGS. 1 to 2, a cable connector assembly 100 in accordance with the first embodiment of the present invention for mating with a complementary connector (not shown). And the cable connector assembly 100 comprises a connector 1, a cable 2 connected with the connector 1 and a cover 3 enclosing the connector 1 and a part of the cable 2. The connector 1 comprises an insulative housing 10, a plurality of contacts 11 received in the insulative housing 10, a spacer 12 assembled to a rear portion of the insulative housing 10, an insulative pressing piece 13 assembled in the spacer 12 along a mating direction, a metallic shielding 14 enclosing the insulative housing 10, and a metallic shell 15 enclosing a rear end of the metallic shielding 14 and a front end of the cable 2.

Referring to FIGS. 1 to 2, the insulative housing 10 defines an upper wall 101, a bottom wall 102 and a pair of side walls 103 connecting with the upper wall 101 and the bottom wall 102. Two rows of terminal receiving passages are respectively formed in an inner surface of the upper and bottom walls 101, 102 of the insulative housing 10. And the upper row of terminal receiving passages include a plurality of first terminal receiving passages 104, the lower row of terminal receiving passages include a plurality of second terminal receiving passages 105. And the number of the second terminal receiving passages 105 is larger than that of the first terminal passages 104.

Referring to FIGS. 1 to 2, the plurality of contacts 11 comprises two rows and received in the insulative housing 10 along the mating direction. Each contact 11 comprises a mating portion 110, a tail portion 112 and a retention portion 111 disposed between the mating portion 110 and the tail portion 112. The retention portions 111 of the contacts 11 are received in the first terminal receiving passages 104 and the second terminal receiving passages 105. The tail portions 112 of the contacts 11 extend beyond a rear surface of the insulative housing 10.

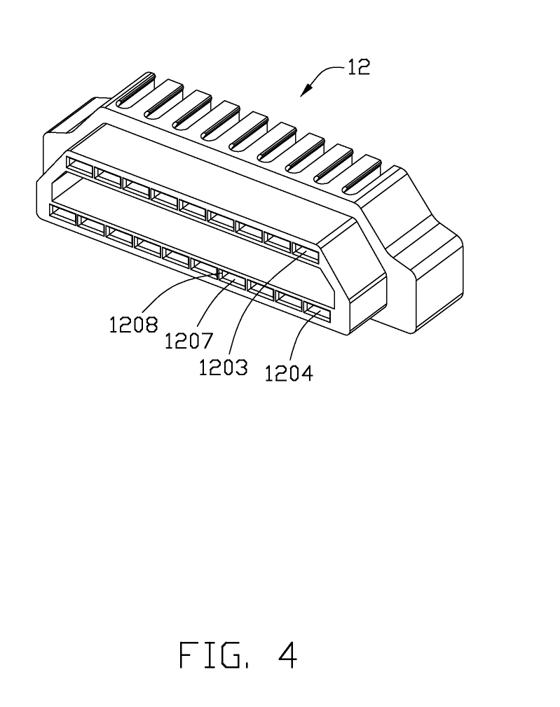

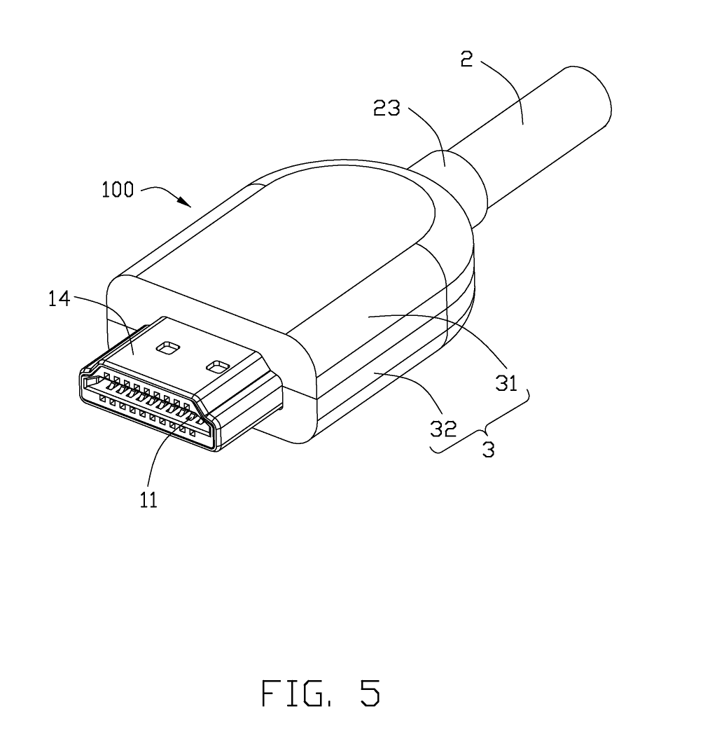

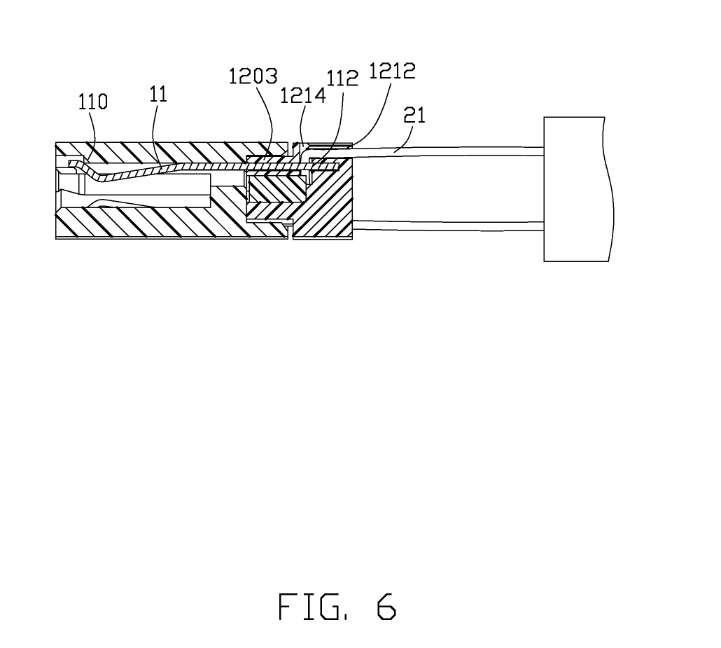

Referring to FIGS. 1 to 6, the spacer 12 comprises a main portion 121 and a front portion 120 extending forwardly from the main portion 121. The front portion 120 defines an upper wall 1200 and a bottom wall 1201. A first groove 1203 formed in the upper wall 1200 and a second groove 1204 is formed in the bottom wall 1201. A plurality of clapboards 1208 are formed in the first groove 1203 and the second groove 1204 to divide the first groove 1203 and the second groove 1204 into several terminal grooves 1207. The terminal grooves 1207 are respectively in alignment with the first terminal receiving passages 104 and the second terminal receiving passages 105 along a front-to-rear direction. A receiving cavity 1205 is formed between the upper wall 1200 and the bottom wall 1201 for receiving the insulative piece 13. The main portion 121 defines a top surface 1210 and a lower surface 1211. The main portion 121 defines a plurality of first receiving slots 1212 and second receiving slots 1213 respectively formed on the top and bottom surface 1210,1211. The spacer 12 defines a plurality of first and second vertical holes 1214, 1215. The first grooves 1203 communicate with the first receiving slots 1212 by the first vertical holes 1214, The second grooves 1204 communicate with the second receiving slots 1213 by the second vertical holes 1215.

Referring to FIGS. 1 to 2, the metallic shielding 14 comprises a rear frame portion 140 for receiving the main portion 121 of the spacer 12 and a front portion 141 extending forwardly from the frame portion 140 for receiving the insulative housing 10.

Referring to FIGS. 1 to 2, the cable 2 comprises a plurality of wires 21 and an insulative jacket 22 enclosing the wires 21. The cable 2 also defines a strain relief 23 surrounding the cable 2. The strain relief 2 comprises a round retaining portion 230 and a protruding portion 231 formed in the front of the retaining portion 230.

Referring to FIGS. 1 to 2, the cover 3 comprises an upper cover 31 and a lower cover 32 assembled with each other. The lower cover 32 defines a pair of positioning holes 320 formed at two sides wall thereof. The upper cover 31 defines a pair of posts 310 cooperating with the positioning holes 320. The upper cover 31 and the lower surface 32 respectively defines a cable holder portion 311,321 formed on a rear wall thereof.

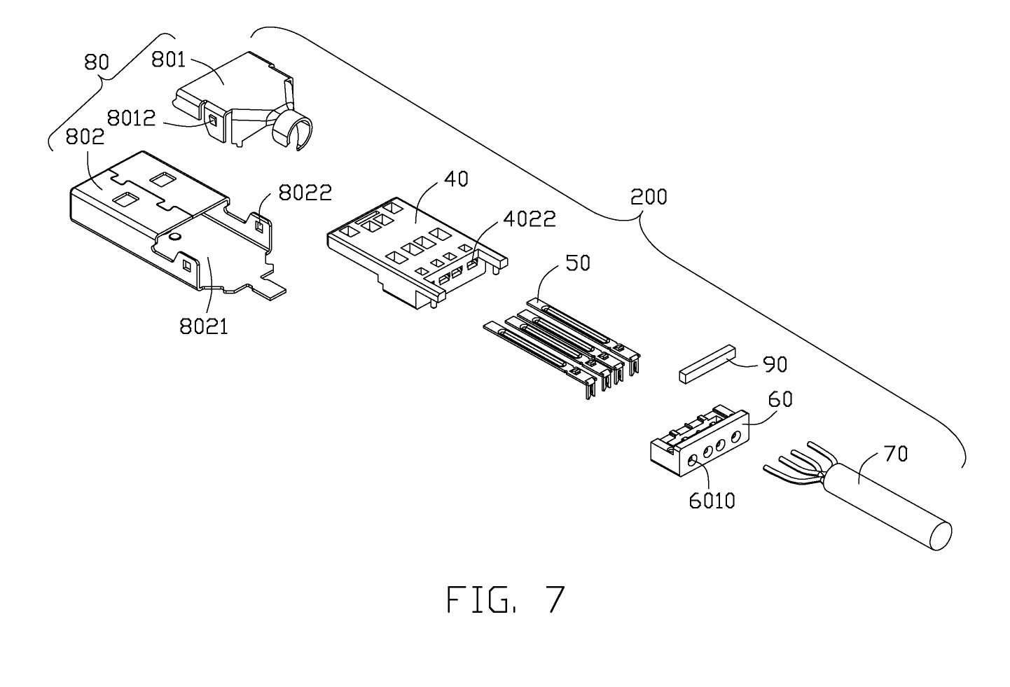

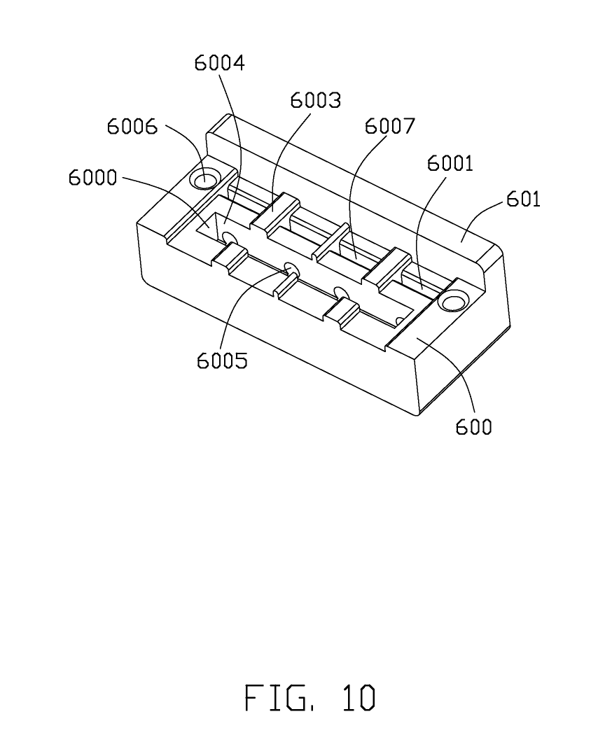

Referring to FIGS. 7 to 10, a cable connector assembly 200 in accordance with the second embodiment of the present invention comprises an insulative housing 40, a plurality of contacts 50 received in the insulative housing 40, a spacer 60 assembled to a rear end of the insulative housing 40, an insulative piece 90 received in the spacer 60 along a vertical direction perpendicular to a mating portion and a metallic shell 80 enclosing the insulative housing 40.

Referring to FIGS. 7 to 10, the insulative housing 40 comprises a front portion 401 and a rear portion 402. The insulative housing 40 defines a pair of projections 4020 formed at two lateral sides of a bottom surface of the rear portion 402 thereof. The projections 4020 extends rearwardly from the rear surface of the rear portion 402, The projections 4020 defines a position post 4021 thereof. A plurality of terminal passages 4022 are extending forwardly from the rear surface of the rear portion 402 to an upper surface of the front portion 401.

Referring to FIGS. 7 to 10, each contact 50 is generally in a L-shape. Each contact 50 comprises a retention portion 500, a mating portion 501 extending forwardly from the retention portion 500 and a tail portion 502 extending upwardly from the retention portion 500. Each tail portion 502 defines a slot for receiving a wire 700 of the cable 7.

Referring to FIGS. 7 to 10, the spacer 60 comprises a front main portion 600 and a rear portion 601 extending backwardly from the main portion 600. The main portion 600 defines a depression 6000 and a groove 6001 depressed from a bottom surface thereof. And a block 6004 is arranged between the depression 6000 and the groove 6001. Three clapboards 6003 formed in the groove 6001 to divide the groove 6001 into four terminal grooves 6007. A distance between the adjacent clapboards 6003 is equal to the width between the retention portions 500 of the contacts 50. A plurality of slots are formed in a rear surface of the spacer 60 and extended into the depression 6000 along a front-to-rear direction. The spacer 60 defines a pair of position holes 6006 at opposite sides of the upper surface.

Referring to FIGS. 7 to 10, the cable 70 comprises a plurality of wires 700 and an insulative jacket (not numbered) enclosing the wires 700.

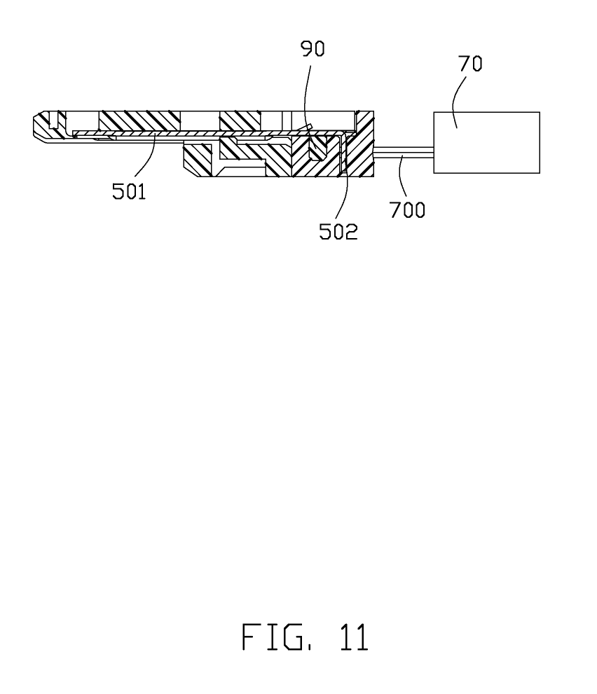

Referring to FIGS. 7 to 11, the metallic shell 80 comprises a first shell 801 and a second shell 802 assembled with each other along a vertical direction perpendicular to the mating direction. The first shell 801 comprises a U-Shaped first shielding portion 8010 and a cable holder portion 8011 connecting with the rear edge of the first shell 801. The second shell 802 comprises a rectangular frame 8020 and a U-Shaped shielding portion 8021 extending rearwardly from the rear edge of the lower surface of the hollow 8020. The first shell 801 defines a pair of locking taps 8012 formed on two lateral walls thereof. The second shell 802 defines a pair of locking holes 8022 cooperating with the locking taps 8012 to lock the first shell 801 and the second shell 802 together.

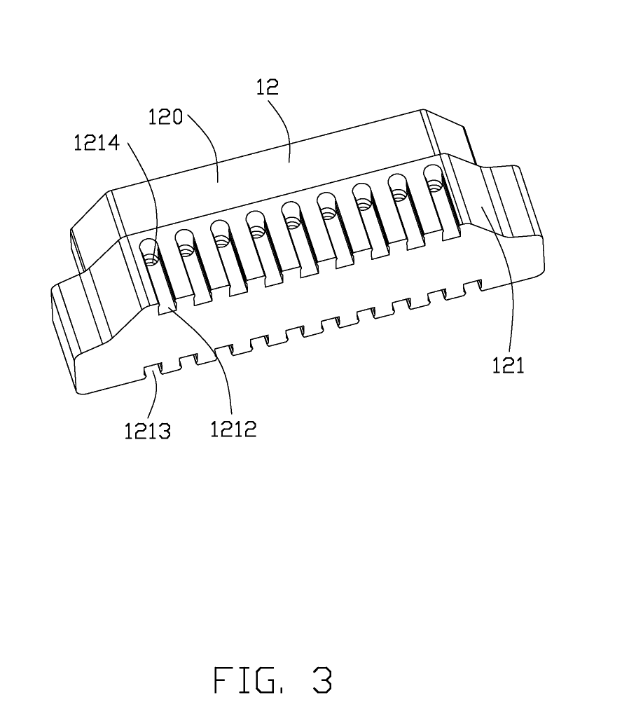

Referring to FIGS. 1 to 2 and in conjunction with FIGS. 3 to 6, in assemble with the first embodiment of the cable connector assembly 100, the metallic shell 15 is assembled to the out of the cable 2, the insulative jackets 22 of the front section of cable 2 is removed away to expose the corresponding wires 21 outside, and the wires 21 are divided into two rows, the upper row is received in the first receiving slots 1212 and the lower row is received in the second receiving slots 1213, and the wires 21 extending into the first and second vertical slots 1214,1215. The insulative piece 13 is assembled in the receiving cavity 1205 along a mating direction, and the insulative piece 13 abuts against the wires 21 extending into the vertical slots 1214,1215. The contacts 11 are assembled to the insulative housing 10 and the retention portion 111 are received in the first terminal receiving passages 104 and the second terminal receiving passages 105, the tail portion 112 extending beyond the rear surface of the insulative housing 10. Then aforementioned spacer 12 and the cable 2 are disposed into the insulative housing 10, the tail portion 112 is received in the terminal grooves 1207,1208 and connecting with the wires 21 extending into the vertical slots 1214,1215. And the same time, the front portion 120 of the spacer 12 received into the insulative housing 10, and the main portion 121 extends beyond the rear surface of the insulative housing 10.

The metallic shielding 14 is assembled to the outside of the insulative housing 10, and the insulative housing 10 is disposed in the front portion 141, the main portion 121 is disposed in the frame portion 140, the metallic shell 15 is removed forwardly and joint with the metallic shielding 14. The aforementioned elements are disposed in the lower cover 32, and the protruding portion 231 is disposed in the front of the cable holder portion 321, with the lower section of the round retaining portion 230 locking in the cable holder portion 321 and the upper cover 31 is assembled on the lower cover 32 with the lower section of the round retaining portion 230 locked in the cable holder portion 321. Thus, the first embodiment of the cable connector assembly 100 is assembled.

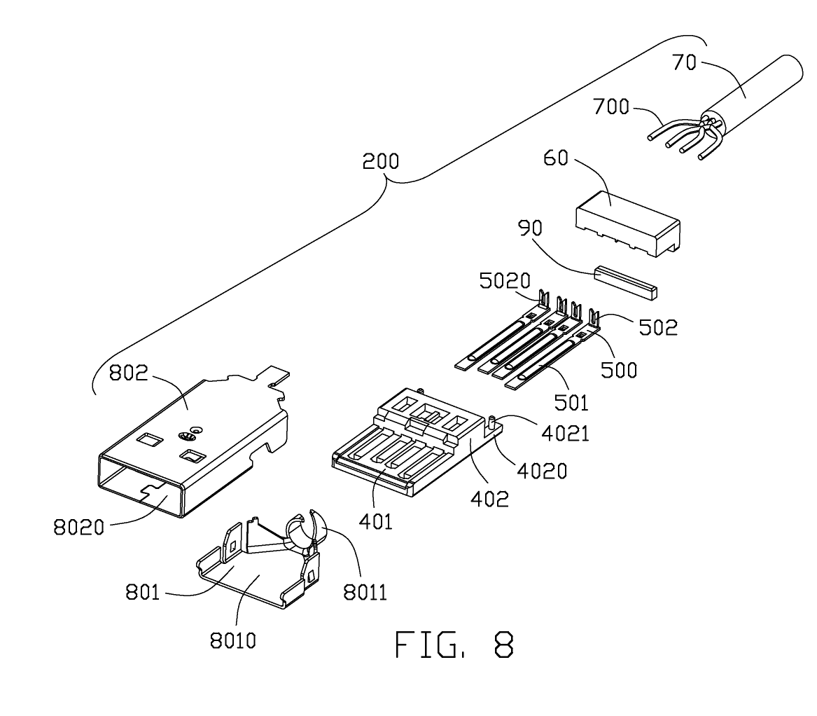

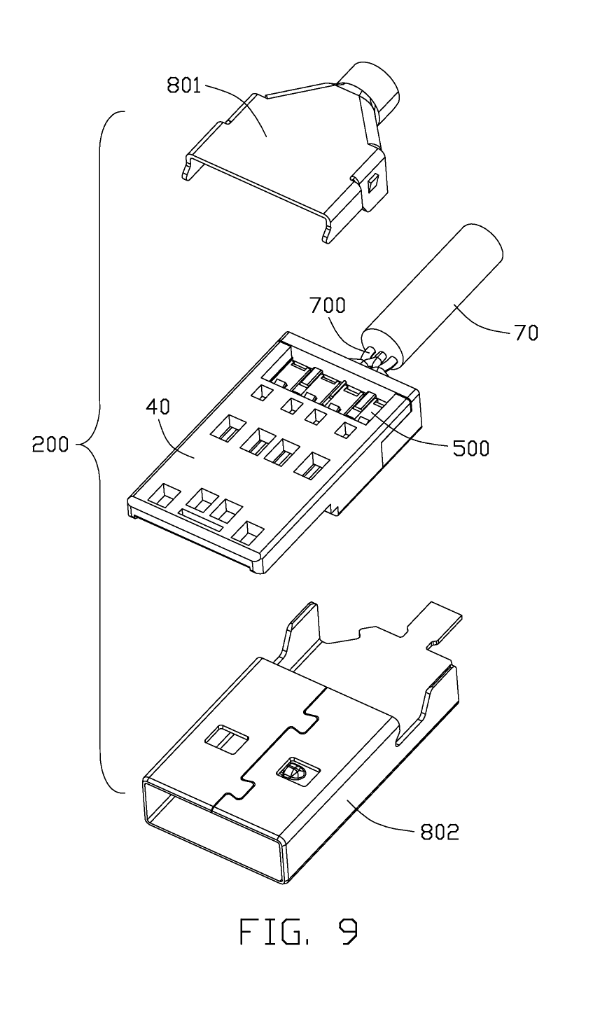

Referring to FIGS. 7 to 8 and in conjunction with FIGS. 9 to 11, in assemble with the second embodiment of the cable connector assembly 100, the contacts 50 are received in the insulative housing 40, with the mating portion 501 exposed in the upper surface of the front portion 401, the retention portion 500 and the tail portion 502 extending beyond the rear surface of the terminal passages 4022.

The insulative piece 90 is locked in the depression 6000 along the up-to-down direction to assemble the cable 70 in the spacer 60, and the aforementioned insulative piece 90, spacer 60 and the cable 70 are disposed in the rear portion of the insulative housing 40, with the retention portion 500 of the contacts 50 are locked between the clapboards 6003, the rail portions 502 are received in the groove 6001 and connecting with the cable 70 to achieve the connection of the contacts 50 and the cable 70. The position posts 4021 are locked in the position holes 6006 to assemble the spacer 60 and the insulative housing 40 together. Then, the shielding shell 80 is assembled in the aforementioned insulative housing 40, the contacts 50, the spacer 60, the insulative piece 90 and the cable 70. Thus, the second embodiment of the cable connector assembly 100 is assembled.

Both the first embodiment of the cable connector assembly and the second embodiment of the cable connector assembly comprises a insulative piece, the insulative piece is assembled in the spacer to fix the cable in the spacer for connecting with the contacts, in this way, the contacts connecting with the cable without the traditional method of soldering process.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable connector assembly, comprising:
an insulative housing;
a plurality of contacts disposed in the insulative housing, each contact having a tail portion extending rearwardly and exposed out of the insulative housing;
a spacer assembled to a rear end of the insulative housing, and the spacer defining a plurality of receiving slots, a receiving cavity located in front of the receiving slots, and a plurality of vertical holes communicate with the receiving slots and the receiving cavity;
a cable having a plurality of wires extending into the receiving cavity through the receiving slots and the vertical holes, the tail portions of the contacts extended into the spacer and electrically connected with the wires; and
an insulative piece received in the receiving cavity and press the wires.

2. The cable connector assembly as claimed in claim 1, wherein the receiving slots are located in the front section of the main portion and extending into and communicating with the back end of the receiving cavity along a up-to-down direction.

3. The cable connector assembly as claimed in claim 2, wherein the spacer comprises a groove parallel to the receiving cavity and the groove is disposed between the receiving cavity and the back surface of the spacer.

4. The cable connector assembly as claimed in claim 3, wherein a plurality of clapboards formed in the groove to divide the groove into several terminal grooves.

5. The cable connector assembly as claimed in claim 4, wherein the contact comprises a mating portion relative to the tail portion and a retention portion disposed between the mating portion and the tail portion, and the tail portion of the contacts assembled in the grooves and connecting with the cable.

6. The cable connector assembly as claimed in claim 5, wherein the insulative piece disposed in the spacer and closing with the inner surface of the cavity.

7. The cable connector assembly as claimed in claim 6, wherein the vertical holes extending along the perpendicular direction.

8. The cable connector assembly as claimed in claim 7, wherein the receiving cavity is depressed backwardly from the front surface of the spacer.

9. The cable connector assembly as claimed in claim 6, wherein the receiving slots extending along the front-to-back direction.

10. The cable connector assembly as claimed in claim 7, wherein the receiving cavity is depressed upwardly from the bottom surface of the spacer.

11. The cable connector assembly as claimed in claim 8, wherein two rows of terminal receiving passages formed in the upper and bottom walls of the insulative housing, and the terminal receiving passages connecting with the terminal grooves.

12. The cable connector assembly as claimed in claim 11, wherein the retention portion of the contacts received in the terminal grooves.

13. The cable connector assembly as claimed in claim 10, wherein the insulative housing defines a pair of projections at two lateral sides of a bottom surface of the insulative housing thereof and the projections extend rearwardly from the rear surface of the insulative housing.

14. The cable connector assembly as claimed in claim 13, wherein the projections defines a position post thereof.

15. The cable connector assembly as claimed in claim 14, wherein the upper surface of the spacer defines a pair of position holes mating with the position posts at opposite sides thereof.

16. A cable connector assembly comprising:
an insulative housing defining a mating port and a plurality of passageways each extending along a front-to-back direction and communicating with the mating port;
a plurality of contacts disposed in the corresponding passageways, respectively, each of said contacts defining a contacting section exposed unto the mating port and a tail section exposed out of the corresponding passageway, the tail section being equipped with a lance at a rear end;
a spacer located behind the housing and defining therein a plurality of front passages into which the corresponding tail sections are received, a plurality of rear passages communicating with the corresponding front passages in a perpendicular manner, and a receiving cavity communicating with said rear passages;
a plurality of wires assembled into the corresponding rear passages, and pierced by the corresponding tail sections, respectively; and
a pressing piece assembled into the receiving cavity to press against the corresponding wires.

17. The cable connector assembly as claimed in claim 16, wherein the receiving cavity is configured to allow the pressing piece to be inserted thereinto in a direction perpendicular to the rear passages.

18. The cable connector assembly as claimed in claim 16, wherein the pressing piece presses against distal ends of the corresponding wires, and the corresponding tail section pierces into the corresponding wire at a position behind said distal end axially.

19. The cable connector assembly as claimed in claim 16, wherein the tail section having the lance at the end in a coplanar manner, essentially extends in a direction parallel to the passageways.

20. The cable connector assembly as claimed in claim 16, wherein the rear passages are of a tubular shape and dimensioned to comply with diameter of the wires for circumferentially surrounding the corresponding wires, respectively.
